(19) United States
(12) Patent Application Publication
(10) Pub. No.: US 2026/0176399 A1
(43) Pub. Date: Jun. 25, 2026

(54) HYDROPHILIC COMPOUNDS AND FABRICS

(71) Applicant: INDUSTRIAL TECHNOLOGY RESEARCH INSTITUTE, Chutung (TW)

(72) Inventors: Yi-Chun LIAO, Toufen City (TW); Kuei-Yen HUANG, Hsinchu City (TW); Jui-Chen LIU, Baoshan Township (TW); Chih-Lin SU, Zhubei City (TW); Chih-Lung CHEN, Zhudong Township (TW); Fen-Mei CHANG, Hsinchu City (TW); Chang-Jung CHANG, Taoyuan City (TW)

(73) Assignee: INDUSTRIAL TECHNOLOGY RESEARCH INSTITUTE, Chutung (TW)

(21) Appl. No.: 19/183,439

(22) Filed: Apr. 18, 2025

(30) Foreign Application Priority Data
Dec. 23, 2024 (TW) 113150094

(51) Int. Cl. C08F 222/02; C08F 2/10; C08F 4/04; C08F 4/30; C08F 222/10; D06M 15/263; D06M 101/32; D06M 101/34

(52) U.S. Cl. CPC C08F 222/02; C08F 2/10; C08F 4/04; C08F 4/30; C08F 222/102; D06M 15/263; D06M 2101/32; D06M 2101/34

(57) ABSTRACT

A hydrophilic compound is formed by reacting an esterified itaconic acid with an unsaturated organic acid or an unsaturated organic alcohol through a free radical reaction. The esterified itaconic acid is formed by reacting an itaconic acid with a C₄₋₁₂ linear diol through an esterification reaction. The unsaturated organic acid is CₙH₂ₙ₋ₓ(COOH)ₓ, wherein n is an integer of 2 to 8, and x is an integer of 1 to 3. The unsaturated organic alcohol is CₘH_{2m-y}(OH)_{y}, wherein m is an integer of 3 to 8, and y is an integer of 1 to 3.

### CROSS REFERENCE TO RELATED APPLICATIONS

The present application is based on, and claims priority from, Taiwan Application Serial Number 113150094, filed on Dec. 23, 2024, the disclosure of which is hereby incorporated by reference herein in its entirety.

### TECHNICAL FIELD

The technical field relates to a hydrophilic compound, and in particular it relates to a fabric adsorbing the hydrophilic compound.

### BACKGROUND

The global fiber chemical industry has a market value of 8 billion US dollars. The main softeners for textiles that are currently commercially available are modified organic silicon compositions, and their biomass content is generally less than 35%. In addition, textile processing usually utilizes a variety of additives to achieve properties such as softness, and moisture-wicking.

Accordingly, a novel softener with multiple functions is needed to simultaneously provide the fabric properties, such as softness, moisture absorption, tactility, and other characteristics.

### SUMMARY

One embodiment of the disclosure provides a hydrophilic compound formed by reacting an esterified itaconic acid with an unsaturated organic acid or an unsaturated organic alcohol through a free radical reaction. The esterified itaconic acid is formed by reacting an itaconic acid with a C₄₋₁₂ linear diol through an esterification reaction. The unsaturated organic acid is CₙH₂ₙ₋ₓ(COOH)ₓ, n is an integer of 2 to 8, and x is an integer of 1 to 3, and wherein the unsaturated organic alcohol is CₘH_{2m-y}(OH)_{y}, m is an integer of 3 to 8, and y is an integer of 1 to 3.

One embodiment of the disclosure provides a fabric. The fabric includes a plurality of fibers interwoven with each other. The described hydrophilic compound is adsorbed on the fibers.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a hydrophilic compound formed by reacting an esterified itaconic acid with an unsaturated organic acid or an unsaturated organic alcohol through a free radical reaction, wherein the esterified itaconic acid is formed by reacting an itaconic acid with a C₄₋₁₂ linear diol through an esterification reaction. For example, the itaconic acid and the C₄₋₁₂ linear diol can be added to water, and H₂SO₄ and hydroquinone can be then added to the water, which is heated to 140 to 180° C. and stirred at 500 rpm for 5 to 6 hours, thereby obtaining the esterified itaconic acid. If the temperature of the esterification reaction is too low, the esterification reaction cannot proceed. If the temperature of the esterification reaction is too high, a polyester (e.g., a polyester with a main chain of I-A-I-A-I-A . . . , in which I is a repeating unit corresponding to the itaconic acid, and A is a repeating unit corresponding to the linear diol) other than the esterified itaconic acid (e.g., a compound with a main structure of I-A formed by reacting one carboxylic acid group of one itaconic acid with one alcohol group of one linear diol through the esterification reaction, or I-A-I formed by reacting two carboxylic acid groups of two itaconic acids with two terminal alcohol groups of one linear diol through the esterification reaction) will be formed.

In some embodiments, the C₄₋₁₂ linear diol is butanediol, 1,12-dodecanediol, or a combination thereof. If the carbon number of the linear diol is too low, the fabric treated by the disclosed hydrophilic compound will be too stiff and have poor tactility. If the carbon number of the linear diol is too high, the treated fabric will have insufficient moisture absorption and reduced hydrophilicity.

An initiator such as K₂S₂O₈ or water-soluble azo initiator is dissolved in water, and the esterified itaconic acid and the unsaturated organic acid or the unsaturated organic alcohol are then dropwise added to the aqueous solution. The aqueous solution is controlled to be slightly acidic to neutral (pH=5 to 7). The aqueous solution is heated to 65° C. to 85° C. and continuously stirred to be uniformly mixed, enabling the initiator to generate free radicals. As a result, the double bond of the esterified itaconic acid and the double bond of the unsaturated organic acid or the unsaturated organic alcohol undergo a free radical reaction, to form the hydrophilic compound. If the pH value of the aqueous solution is too low, a self-crosslinking reaction will easily occur to increase side-products. If the pH value of the aqueous solution is too high, an ionized carboxylic acid group will easily form, thereby lowering the reactivity of the unsaturated double bonds. If the temperature of the aqueous solution is too low, the decomposition rate of the initiator will tend to decrease, resulting in an insufficient generation of free radicals for reaction. If the temperature of the aqueous solution is too high, excessive free radicals generation will lead to an increase of side-products, which can negatively affect the performance of the final product.

In some embodiments, the unsaturated organic acid is CₙH₂ₙ₋ₓ(COOH)ₓ, n is an integer of 2 to 8, and x is an integer of 1 to 3. If the carbon number of the unsaturated organic acid is too low, the fabric treated by the disclosed hydrophilic compound will have insufficient softness and poor tactility. If the carbon number of the unsaturated organic acid is too high, the treated fabric will have insufficient moisture absorption and reduced hydrophilicity. For example, the unsaturated organic acid can be acrylic acid, butenedioic acid, octenic acid, or a combination thereof.

In some embodiments, the unsaturated organic alcohol is CₘH_{2m-y}(OH)_{y}, m is an integer of 3 to 8, and y is an integer of 1 to 3. If the carbon number of the unsaturated organic alcohol is too low, the fabric treated by the disclosed hydrophilic compound will have insufficient softness and poor tactility. If the carbon number of the unsaturated organic alcohol is too high, the treated fabric will have insufficient moisture absorption and reduced hydrophilicity. For example, the unsaturated organic alcohol is 3-butene-1,2-diol, 7-octene-1,2-diol, 2-methylene-1,4-butanediol, or a combination thereof.

In some embodiments, the itaconic acid and the C₄₋₁₂ linear diol have a molar ratio of 1.2:1 to 2:1. If the amount of the linear diol is too low, some itaconic acid may not undergo esterification reaction with the linear diol, leaving a non-esterified itaconic acid in the aqueous solution. Although the non-esterified itaconic acid remaining in the solution may increase the hydrophilicity of the product, it will create an imbalance between hydrophilicity and softness, thereby compromising the fabric's comfort. If the amount of the linear diol is too high, some linear diol may not undergo esterification reaction with the itaconic acid, and the non-esterified linear diol left in the solution may disrupt the subsequent free radical reaction, and negatively affect the hydrophilicity and softness of the treated fabric.

In some embodiments, the itaconic acid and the unsaturated organic acid or the unsaturated organic alcohol have a molar ratio of 1:0.8 to 1:1.2. If the amount of the unsaturated organic acid or the unsaturated organic alcohol is too low or too high, a self-crosslinking reaction will easily occur and the double bonds participating in the radical reaction will be incomplete. Therefore, the final product will have poor hydrophilicity and unsatisfactory tactility (e.g., lacking elasticity).

In some embodiments, the itaconic acid is a biomass itaconic acid. As such, the biomass content of the softener will be largely increased to meet the requirement of environmental protection.

One embodiment of the disclosure provides a fabric, including a plurality of fibers interwoven with each other; wherein the disclosed hydrophilic compound is adsorbed on the fibers. For example, the hydrophilic compound can be formulated as an aqueous solution (having a concentration of about 5 wt % to 10 wt %). The fabric is then immersed into the aqueous solution, and then treated by a padder, so that the fibers of the fabric can fully adsorb the aqueous solution and the hydrophilic compound thereof. The fabric is then heat set at 140 to 190° C. for about 90 to 150 seconds, to obtain the fabric of fibers adsorbing the hydrophilic compound.

In some embodiments, the fibers include nylon fibers, polyester fibers, or a combination thereof. The fibers such as nylon fibers can be biomass materials to meet the requirement of environmental protection.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity.

### EXAMPLES

In the following Examples, the stiffness of nylon fabric treated by a softener was measured according to the ASTM D1388 standard, with lower measured values indicating better softness. The water absorbency of nylon fabric treated by a softener was measured according to the AATCC 79 test, with lower measured values indicating better absorption and higher hydrophilicity. The total hand value (THV) of nylon fabric treated by a softener was subjectively evaluated according to the HESC Standard of Hand Evaluation-Second Edition, as specified by the Hand Evaluation and Standardization Committee of The Textile Machinery Society of Japan. The sample fabric was evaluated by comparing the sensation felt of the sample by the fingers with that of a standard reference fabric. These sensory perceptions include hardness, smoothness, richness, softness, stiffness, compression, and others. The THV value was graded from 1 to 5, with 5 indicating very good and 1 indicating very poor.

### Example 1

10 g of itaconic acid (0.0769 mole) and 4.6 g of butanediol (0.0513 mole) were added to 40 mL of water. H₂SO₄ (0.03 wt %) and hydroquinone (0.5 wt %) were then added to the water, which was then heated to 140° C. and stirred at 500 rpm to react for 5 hours to obtain an esterified itaconic acid.

0.2 g of an initiator K₂S₂O₈ was dissolved in 2 mL of water, the esterified itaconic acid and 6.8 g of 3-butene-1,2-diol (0.0769 mole) were then dropwise added to the aqueous solution, and the aqueous solution was controlled to be slightly acidic to neutral (pH=5 to 7). The aqueous solution was heated to 75° C. and continuously stirred to be uniformly mixed, enabling the initiator to generate free radicals. The double bond of the esterified itaconic acid and the double bond of 3-butene-1,2-diol underwent a free radical reaction to form a hydrophilic compound. As shown in the ¹H NMR spectrum of the hydrophilic compound, the original double bond signals (6.31 ppm and 5.70 ppm) of the esterified itaconic acid disappeared, which proves that the double bond of the esterified itaconic acid and the double bond of 3-butene-1,2-diol underwent a free radical reaction. The chemical structure of the hydrophilic compound is shown below:

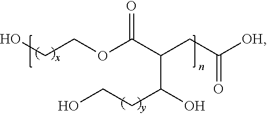

x=3, y=2, and n=1. The major signals of the 1H NMR spectrum of the hydrophilic compound are listed below: NMR (400 MHz, CDCl₃) δ (ppm): 4.71-4.72 (2H, Ester group-H), 3.71-3.75 (5H, —CHₓ—OH, x=1 or 2), 2.07-2.11 (3H, H on carbon next to C═O and overlapping with hydroxy group), 1.26 (8H, CH, CH₂).

The hydrophilic compound was formulated as an aqueous solution (about 5 wt %). A fabric of nylon fibers was immersed into the aqueous solution, and then treated by a padder to fully adsorb the aqueous solution and the hydrophilic compound thereof. The fabric of nylon fibers was heat set at 150° C. for about 120 seconds, thereby obtaining the fabric of nylon fibers adsorbing the hydrophilic compound. The original fabric of nylon fibers before the treatment had a stiffness of higher than 7 cm, a water absorption rate of greater than 5 seconds, and a THV of 1. The fabric of nylon fibers after the treatment had a stiffness of less than or equal to 7 cm, a water absorption rate of less than or equal to 5 seconds, and a THV of 3.

### Example 2

10 g of itaconic acid (0.0769 mole) and 10.4 g of 1,12-dodecanediol (0.0513 mole) were added to 60 mL of water. H₂SO₄ (0.03 wt %) and hydroquinone (0.5 wt %) were then added to the water, which was then heated to 140° C. and stirred at 500 rpm to react for 5 hours to obtain an esterified itaconic acid.

0.4 g of an initiator K₂S₂O₈ was dissolved in 4 mL of water, the esterified itaconic acid and 12.3 g of 7-octene-1,2-diol (0.0769 mole) were then dropwise added to the aqueous solution, and the aqueous solution was controlled to be slightly acidic to neutral (pH=5 to 7). The aqueous solution was heated to 75° C. and continuously stirred to be uniformly mixed, enabling the initiator to generate free radicals. The double bond of the esterified itaconic acid and the double bond of 7-octene-1,2-diol underwent a free radical reaction to form a hydrophilic compound.

The hydrophilic compound was formulated as an aqueous solution (about 5 wt %). A fabric of nylon fibers was immersed into the aqueous solution, and then treated by a padder to fully adsorb the aqueous solution and the hydrophilic compound thereof. The fabric of nylon fibers was heat set at 150° C. for about 120 seconds, thereby obtaining the fabric of nylon fibers adsorbing the hydrophilic compound. The fabric of nylon fibers after the treatment had a stiffness of less than or equal to 5 cm, a water absorption rate of less than or equal to 2 seconds, and a THV of 4.

### Comparative Example 1

10 g of itaconic acid (0.0769 mole) and 3.2 g of ethylene glycol (0.0513 mole) were added to 40 mL of water. H₂SO₄ (0.03 wt %) and hydroquinone (0.5 wt %) were then added to the water, which was then heated to 140° C. and stirred at 500 rpm to react for 5 hours to obtain an esterified itaconic acid.

0.4 g of an initiator K₂S₂O₈ was dissolved in 4 mL of water, the esterified itaconic acid and 12.3 g of 7-octene-1,2-diol (0.0769 mole) were then dropwise added to the aqueous solution, and the aqueous solution was controlled to be slightly acidic to neutral (pH=5 to 7). The aqueous solution was heated to 75° C. and continuously stirred to be uniformly mixed, enabling the initiator to generate free radicals. The double bond of the esterified itaconic acid and the double bond of 7-octene-1,2-diol underwent a free radical reaction to form a hydrophilic compound.

The hydrophilic compound was formulated as an aqueous solution (about 5 wt %). A fabric of nylon fibers was immersed into the aqueous solution, and then treated by a padder to fully adsorb the aqueous solution and the hydrophilic compound thereof. The fabric of nylon fibers was heat set at 150° C. for about 120 seconds, thereby obtaining the fabric of nylon fibers adsorbing the hydrophilic compound. The fabric of nylon fibers after the treatment had a stiffness of less than or equal to 10 cm, a water absorption rate of less than or equal to 5 seconds, and a THV of 2. As shown above, if the itaconic acid reacted with the diol with an excessively low carbon number, the treated fabric would be too stiff and have poor tactility.

### Comparative Example 2

10 g of itaconic acid (0.0769 mole) and 14.7 g of 1,18-octadecanediol (0.0513 mole) were added to 80 mL of water. H₂SO₄ (0.03 wt %) and hydroquinone (0.5 wt %) were then added to the water, which was then heated to 140° C. and stirred at 500 rpm to react for 5 hours to obtain an esterified itaconic acid.

0.4 g of an initiator K₂S₂O₈ was dissolved in 4 mL of water, the esterified itaconic acid and 12.3 g of 7-octene-1,2-diol (0.0769 mole) were then dropwise added to the aqueous solution, and the aqueous solution was controlled to be slightly acidic to neutral (pH=5 to 7). The aqueous solution was heated to 75° C. and continuously stirred to be uniformly mixed, enabling the initiator to generate free radicals. The double bond of the esterified itaconic acid and the double bond of 7-octene-1,2-diol underwent a free radical reaction to form a hydrophilic compound.

The hydrophilic compound was formulated as an aqueous solution (about 5 wt %). A fabric of nylon fibers was immersed into the aqueous solution, and then treated by a padder to fully adsorb the aqueous solution and the hydrophilic compound thereof. The fabric of nylon fibers was heat set at 150° C. for about 120 seconds, thereby obtaining the fabric of nylon fibers adsorbing the hydrophilic compound. The fabric of nylon fibers after the treatment had a stiffness of less than or equal to 5 cm, a water absorption rate of less than or equal to 10 seconds, and a THV of 3. As shown above, if the itaconic acid reacted with the diol with an excessively high carbon number, the hydrophilicity of the treated fabric would be insufficient.

### Comparative Example 3

10 g of itaconic acid (0.0769 mole) and 10.4 g of 1,12-dodecanediol (0.0513 mole) were added to 80 mL of water. H₂SO₄ (0.03 wt %) and hydroquinone (0.5 wt %) were then added to the water, which was then heated to 140° C. and stirred at 500 rpm to react for 5 hours to obtain an esterified itaconic acid.

0.4 g of an initiator K₂S₂O₈ was dissolved in 4 mL of water, the esterified itaconic acid and 3.4 g of vinyl alcohol (0.0769 mole) were then dropwise added to the aqueous solution, and the aqueous solution was controlled to be slightly acidic to neutral (pH=5 to 7). The aqueous solution was heated to 75° C. and continuously stirred to be uniformly mixed, enabling the initiator to generate free radicals. The double bond of the esterified itaconic acid and the double bond of vinyl alcohol underwent a free radical reaction to form a hydrophilic compound.

The hydrophilic compound was formulated as an aqueous solution (about 5 wt %). A fabric of nylon fibers was immersed into the aqueous solution, and then treated by a padder to fully adsorb the aqueous solution and the hydrophilic compound thereof. The fabric of nylon fibers was heat set at 150° C. for about 120 seconds, thereby obtaining the fabric of nylon fibers adsorbing the hydrophilic compound. The fabric of nylon fibers after the treatment had a stiffness of less than or equal to 7 cm, a water absorption rate of less than or equal to 10 seconds, and a THV of 2. As shown above, if the carbon number of the unsaturated organic alcohol undergoing the free radical reaction was too low, the treated fabric would have insufficient hydrophilicity and poor tactility.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A hydrophilic compound, being
formed by reacting an esterified itaconic acid with an unsaturated organic acid or an unsaturated organic alcohol through a free radical reaction,
wherein the esterified itaconic acid is formed by reacting an itaconic acid with a C₄₋₁₂ linear diol through an esterification reaction,
wherein the unsaturated organic acid is CₙH₂ₙ₋ₓ(COOH)ₓ, n is an integer of 2 to 8, and x is an integer of 1 to 3, and
wherein the unsaturated organic alcohol is CₘH_{2m-y}(OH)_{y}, m is an integer of 3 to 8, and y is an integer of 1 to 3.

2. The hydrophilic compound as claimed in claim 1, wherein the C₄₋₁₂ linear diol is butanediol, 1,12-dodecanediol, or a combination thereof.

3. The hydrophilic compound as claimed in claim 1, wherein the unsaturated organic acid is acrylic acid, butenedioic acid, octenic acid, or a combination thereof.

4. The hydrophilic compound as claimed in claim 1, wherein the unsaturated organic alcohol is 3-butene-1,2-diol, 7-octene-1,2-diol, 2-methylene-1,4-butanediol, or a combination thereof.

5. The hydrophilic compound as claimed in claim 1, wherein the itaconic acid and the C₄₋₁₂ linear diol have a molar ratio of 1.2:1 to 2:1.

6. The hydrophilic compound as claimed in claim 1, wherein the itaconic acid and the unsaturated organic acid or the unsaturated organic alcohol have a molar ratio of 1:0.8 to 1:1.2.

7. The hydrophilic compound as claimed in claim 1, wherein the esterification reaction is performed at a temperature of 140° C. to 180° C.

8. The hydrophilic compound as claimed in claim 1, wherein the free radical reaction is performed in the presence of an initiator of K₂S₂O₈ or a water-soluble azo initiator in an aqueous solution of a pH value of 5 to 7 at a temperature of 65° C. to 85° C.

9. The hydrophilic compound as claimed in claim 1, wherein the itaconic acid is a biomass itaconic acid.

10. A fabric, comprising:
a plurality of fibers interwoven with each other; and
the hydrophilic compound as claimed in claim 1 adsorbed on the plurality of fibers.

11. The fabric as claimed in claim 10, wherein the fibers include nylon fibers, polyester fibers, or a combination thereof.
